(19) United States
(12) Patent Application Publication
(10) Pub. No.: US 2014/0043265 A1
(43) Pub. Date: Feb. 13, 2014

(54) SYSTEM AND METHOD FOR DETECTING AND INTERPRETING ON AND OFF-SCREEN GESTURES

(71) Applicant: barnesandnoble.com llc, New York, NY (US)

(72) Inventors: Songan Andy CHANG, Mountain View, CA (US); Abhinayak MISHRA, New York, NY (US); Bennett CHAN, New York, NY (US)

(73) Assignee: barnesandnoble.com llc, New York, NY (US)

(21) Appl. No.: 13/961,796

(22) Filed: Aug. 7, 2013

Related U.S. Application Data
(60) Provisional application No. 61/680,588, filed on Aug. 7, 2012.

(51) Int. Cl. G06F 3/0488

(52) U.S. Cl. CPC G06F 3/04883
USPC 345/173

(57) ABSTRACT

A system and method for the detection and interpretation of unique and distinctive gestures by extending the input sensor area to a perimeter area beyond the display area. In systems that have more flexible requirements, an additional gesture band can be located within the display area. The extended input sensor area allows for new gestures that are facilitated by the expanded sensor area. One gesture initiated around the corner of the device is most useful as ‘next’ and ‘previous’ navigation gestures found in traditional electronic publication reader applications, but can be overloaded or repurposed to serve different functions depending on the context. An gesture is used to initiate screen capture process. A third gesture is a corner-fold bookmark gesture and is used to bookmark a page by ‘dog earing’ the corner of the page electronically. An additional gesture, also initiated at the corner of the device launches selectable icons for the most frequently used applications.

### FIELD OF THE INVENTION

The present invention generally relates to the operation of mobile devices, and more particularly to devices that detect and interpret a user's gestures.

### BACKGROUND OF THE INVENTION

A touchscreen is an electronic visual display that can detect the presence and location of a touch within the display area. The term generally refers to touching the display of the device with a finger or hand. Touchscreens can also sense other passive objects, such as a stylus. Touchscreens are common in devices such as game consoles, all-in-one computers, tablet computers, electronic readers (e-readers), and smartphones.

A touchscreen has two main attributes. First, it enables a user to interact directly with what is displayed, rather than indirectly with a pointer controlled by a mouse or touchpad. Secondly, it lets a user do so without requiring any intermediate device that would need to be held in the hand (other than a stylus, which is optional for most modern touchscreens).

Until recently, most consumer touchscreens could only sense one point of contact at a time, and few have had the capability to sense how hard one is touching. This is starting to change with the commercialization of multi-touch technology.

The popularity of smart phones, tablets, portable video game consoles and many types of information appliances is driving the demand and acceptance of common touchscreens, for portable and functional electronics. With a display of a simple smooth surface, and direct interaction without any hardware, e.g., a keyboard or mouse) between the user and content, fewer accessories are required.

Touchscreens are popular in the hospitality field, and in heavy industry, as well as kiosks such as museum displays or room automation, where keyboard and mouse systems do not allow a suitably intuitive, rapid, or accurate interaction by the user with the display's content.

Historically, the touchscreen sensor and its accompanying controller-based firmware have been made available by a wide array of after-market system integrators, and not by display, chip, or motherboard manufacturers. Display manufacturers and chip manufacturers worldwide have acknowledged the trend toward acceptance of touchscreens as a highly desirable user interface component and have begun to integrate touchscreens into the fundamental design of their products.

Although there a many technologies used to enable touch screens, the most common are Resistive, Capacitive and Infrared

A resistive touchscreen panel comprises several layers, the most important of which are two thin, transparent, electrically-resistive layers separated by a thin space. These layers face each other, with a thin gap between. One resistive layer is a coating on the underside of the top surface of the screen. Just beneath it is a similar resistive layer on top of its substrate. One layer has conductive connections along its sides, the other along top and bottom.

When an object, such as a fingertip or stylus tip, presses down on the outer surface, the two layers touch to become connected at that point. The panel then behaves as a pair of voltage dividers, one axis at a time. For a short time, the associated electronics (device controller) applies a voltage to the opposite sides of one layer, while the other layer senses the proportion of voltage at the contact point. That provides the horizontal [x] position. Then, the controller applies a voltage to the top and bottom edges of the other layer (the one that just sensed the amount of voltage) and the first layer now senses height [y]. The controller rapidly alternates between these two modes. The controller sends the sensed position data to the CPU in the device, where it is interpreted according to what the user is doing.

Resistive touchscreens are typically used in restaurants, factories and hospitals due to their high resistance to liquids and contaminants. A major benefit of resistive touch technology is its low cost. Disadvantages include the need to press down, and a risk of damage by sharp objects. Resistive touchscreens also suffer from poorer contrast, due to having additional reflections from the extra layer of material placed over the screen.

A capacitive touchscreen panel consists of an insulator such as glass, coated with a transparent conductor such as indium tin oxide (ITO). As the human body is also an electrical conductor, touching the surface of the screen results in a distortion of the screen's electrostatic field, measurable as a change in capacitance. Different technologies may be used to determine the location of the touch. The location is then sent to the controller for processing. Unlike a resistive touchscreen, one cannot use a capacitive touchscreen through most types of electrically insulating material, such as gloves. A special capacitive stylus, or a special-application glove with an embroidered patch of conductive thread passing through it and contacting the user's fingertip. This disadvantage especially affects usability in consumer electronics, such as touch tablet PCs and capacitive smartphones in cold weather.

In surface capacitance technology, only one side of the insulator is coated with a conductive layer. A small voltage is applied to the layer, resulting in a uniform electrostatic field. When a conductor, such as a human finger, touches the uncoated surface, a capacitor is dynamically formed. The sensor's controller can determine the location of the touch indirectly from the change in the capacitance as measured from the four corners of the panel. As it has no moving parts, it is moderately durable but has limited resolution, is prone to false signals from parasitic capacitive coupling, and needs calibration during manufacture.

Projected Capacitive Touch (PCT) technology is a capacitive technology which permits more accurate and flexible operation. An X-Y grid is formed either by etching a single conductive layer to form a grid pattern of electrodes, or by etching two separate, perpendicular layers of conductive material with parallel lines or tracks to form the grid (comparable to the pixel grid found in many LCD displays) that the conducting layers can be coated with further protective insulating layers, and operate even under screen protectors, or behind weather- and vandal-proof glass. Due to the top layer of a PCT being glass, it is a more robust solution than resistive touch technology. Depending on the implementation, an active or passive stylus can be used instead of or in addition to a finger. This is common with point of sale devices that require signature capture. Gloved fingers may or may not be sensed, depending on the implementation and gain settings. Conductive smudges and similar interference on the panel surface can interfere with the performance. Such conductive smudges come mostly from sticky or sweaty finger tips, especially in high humidity environments. Collected dust, which adheres to the screen due to the moisture from fingertips can also be a problem. There are two types of PCT: Self Capacitance and Mutual Capacitance.

A PCT screen consists of an insulator such as glass or foil, coated with a transparent conductor (Copper, ATO, Nanocarbon or ITO). As the human finger, which is a conductor, touches the surface of the screen a distortion of the local electrostatic field results, measurable as a change in capacitance. Newer PCT technology uses mutual capacitance, which is the more common projected capacitive approach and makes use of the fact that most conductive objects are able to hold a charge if they are very close together. If another conductive object, in this case a finger, bridges the gap, the charge field is interrupted and detected by the controller. An PCT touch screens are made up of an electrode matrix of rows and columns. The capacitance can be changed at every individual point on the grid (intersection). It can be measured to accurately determine the exact touch location. All projected capacitive touch (PCT) solutions have three key features in common: the sensor as matrix of rows and columns; the sensor lies behind the touch surface; and the sensor does not use any moving parts.

In mutual capacitive sensors, there is a capacitor at every intersection of each row and each column. A 16-by-14 array, for example, would have 224 independent capacitors. A voltage is applied to the rows or columns. Bringing a finger or conductive stylus close to the surface of the sensor changes the local electrostatic field which reduces the mutual capacitance. The capacitance change at every individual point on the grid can be measured to accurately determine the touch location by measuring the voltage in the other axis. Mutual capacitance allows multi-touch operation where multiple fingers, palms or styli can be accurately tracked at the same time.

Self-capacitance sensors can have the same X-Y grid as mutual capacitance sensors, but the columns and rows operate independently. With self-capacitance, the capacitive load of a finger is measured on each column or row electrode by a current meter. This method produces a stronger signal than mutual capacitance, but it is unable to resolve accurately more than one finger, which results in “ghosting”, or misplaced location sensing.

An infrared touchscreen uses an array of X-Y infrared LED and photodetector pairs around the edges of the screen to detect a disruption in the pattern of LED beams. These LED beams cross each other in vertical and horizontal patterns. This helps the sensors pick up the exact location of the touch. A major benefit of such a system is that it can detect essentially any input including a finger, gloved finger, stylus or pen. IR sensors are generally used in outdoor applications and point of sale systems which can't rely on a conductor (such as a bare finger) to activate the touchscreen. Unlike capacitive touchscreens, infrared touchscreens do not require any patterning on the glass which increases durability and optical clarity of the overall system.

There are several principal ways to build a touchscreen. The key goals are to recognize one or more fingers touching a display, to interpret the command that this represents, and to communicate the command to the appropriate application.

In the most popular construction techniques, the capacitive or resistive approach, there are typically four layers: 1. a top polyester coated with a transparent metallic conductive coating on the bottom; 2. an adhesive spacer; 3. a glass layer coated with a transparent metallic conductive coating on the top; and 4. an adhesive layer on the backside of the glass for mounting. There are two infrared-based approaches. In one, an array of sensors detects a finger touching or almost touching the display, thereby interrupting light beams projected over the screen. In the other, bottom-mounted infrared cameras record screen touches. In each case, the system determines the intended command based on the controls showing on the screen at the time and the location of the touch.

The development of multipoint touchscreens facilitated the tracking of more than one finger on the screen. Thus, operations that require more than one finger are possible. These devices also allow multiple users to interact with the touchscreen simultaneously.

### SUMMARY OF THE INVENTION

The present invention improves the experience of a user of a touchscreen device, e.g., a computer tablet, by providing an ergonomic navigation and function gestures that are both unique and consistent in portrait and landscape orientation.

The detection and interpretation of unique and distinctive gestures is important in the operation of a touch input device as it avoids confusion with existing system gestures and functions, in order to provide superior performance with respect prior art systems, the present invention provides this capability by extending the input sensor area to a perimeter area beyond the active display area. Optionally, in systems that have more flexible requirements, an additional gesture band can be located within the active display area.

In a preferred embodiment, there are three new gestures that are facilitated by the expanded sensor area. The first involves gestures around the corner of the device. This gesture is most useful as ‘next’ and ‘previous’ navigation gestures found in traditional electronic publication reader applications, but can be overloaded or repurposed to serve different functions depending on the context. A second gesture is used to initiate screen capture process. The third gesture is a corner-fold bookmark gesture and is used to bookmark a page by folding the corner the page electronically (dog-earing).

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a device and gestures in a landscape mode, according to the present invention;

FIG. 2 depicts a device and gestures in a portrait mode, according to the present invention;

FIGS. 3A and 3B illustrate a corner gesture in the portrait and landscape modes respectively;

FIGS. 4A, 4B and 4C depict the operation of a screen capture gesture;

FIG. 5 illustrated a further embodiment of the present invention that has an on-screen gesture band in addition to the off-screen gesture band;

FIGS. 6A and 6B respectively illustrate the subcomponents/regions of each gesture for off-screen and on-screen gesture band systems;

FIGS. 7 and 8 illustrate the corner launcher gesture of the present invention; and

FIG. 9 illustrates the components of an exemplary device.

### DETAILED DESCRIPTION OF THE INVENTION

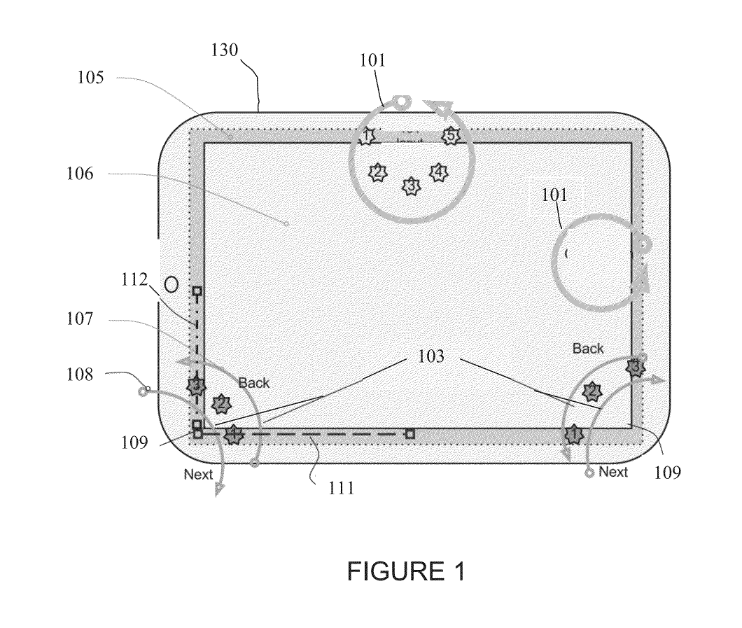

FIG. 1 illustrates a device 130, depicted in a landscape mode, according to the present invention. During investigation into ways to improves touch and pen accuracy along the edges of the active display area 106 where the touch accuracy is significant lower compared to the center of the active display area 106, it was determined that the best way to accomplish this is to extend the touch/pen input sensor beyond the outer limits of the display 106. The present invention thus creates an extra touch and/or stylus sensor band 105 around the active display 106 as shown in FIG. 1.

Although the extra sensor band or off-screen input area 105 does not determine touch locations as accurately as the sensors located in the center of the active display are 106, off-screen input area 105 is fully capable of supporting the edge gesture detection described herein. In the preferred embodiment, the off-screen gestures described herein require the detection of at least one input within the off-screen input band 105 that surrounds the display area 106. In the preferred embodiment, the off-screen input band 105 starts at the display perimeter and continues, for example, for 2 mm or more, creating the area 105 that is able to detect inputs including inputs from touch and/or pen.

For a capacitive touch panel, a touch sensor sheet (not shown), typically made from glass or optically clear plastic film, goes on top of the display. The touch sensor sheet is typically larger than display visible area 106 as extra space is need route the invisible trace or wires. On top of the touch sensor sheet is the cover glass which is what the user physically touches. The cover glass is typically larger than the touch sensor sheet and the display 106. A first array of touch sensors is registered, aligned, with the active display. A second set of sensors, that comprise the off screen band 105 are adjacent to the first set of touch sensors, but are not in registration with the active display 106. In the preferred embodiment, the first and second arrays of touch sensors are integrally formed. Although the term ‘array’ is used herein, one skilled in the appreciates that this term also includes other types of capacitive and/or resistive touch sensors.

The off-screen touch area 105 allows new gestures to be recognized and interpreted as unique and therefore does not interfere with existing user input infrastructures (i.e., established gestures). The uniqueness of these new gestures allow the gestures to be deployed system-wide without interfering function of existing applications. For example, the screen capture gesture described herein can be thought of as the touch equivalent of print-screen hot-keys in personal computers.

FIG. 1 illustrates the device 130 of the present invention in a landscape orientation. In the lower left hand corner 109 there is a vertical gesture area 112 and a horizontal gesture area 111 in the off screen band 105. These two areas 111 and 112 are used to detect a user's gestures at the corner 109. Note that the vertical area 112 extends approximately half way up the vertical side of device 130 from corner 109. Similarly, area 111 extends approximately half way along the horizontal side of device 130 from corner 109. The extent of the length of these areas 111, 112 can be varied. Although not illustrated in FIG. 1, corresponding vertical and horizontal areas exist around the lower right hand corner 110.

The establishment of these gesture detection areas, e.g., 111, 112, allows the device 130 to detect and interpret the user's gestures in the corners 109, 110 of the device 130. As described above, in a preferred embodiment, these corner gestures are used to generate navigational commands to an application running on the device 130.

Illustrated in FIG. 1 are two pairs of corner gestures 103. Turning first to the left hand corner 109, illustrated are a ‘back’ gesture 107 and a ‘next’ gesture 108. The main difference between the next 108 and previous 107 gestures are their directionality as show in FIG. 1. The next gesture 108 is clockwise motion while the back gesture 107 is counter-clockwise. As previously described, these gestures 103 are preferable interpreted by the device 130 as commanding, for example, a reading application to turn to the previous or next page in the electronic publication being viewed on the device 130.

As shown in FIG. 1, for the back gesture 107, the user performs an arc-shaped swipe, starting at point 1 in horizontal detection area 111 of off screen band 105, proceeds to point 2 on the display area 106 and ends at point 3 in the vertical detection area 112 of off screen band 105. Although there may, and typically would be, many additionally detected points in each of these areas, 111, 112 and 106, in order to properly detect and interpret the user's gesture, there should be at least one detected point in each of these areas 111, 112 and 106.

When the device 130 detects this type of swipe 107 through these three areas, it interprets that the user intended to perform a ‘hack’ function and sends this command to the reader application. In a similar, but opposite motion 108, if the user performs a swipe through point 3 in the vertical detection area 112 of off screen band 105, proceeds through point 2 on the display 106 and ends at point 1 in horizontal detection area 111 of off screen hand 105, the device 130 detects this gesture and interprets that the user's intent is to perform a ‘next’ operation.

As further shown in FIG. 1, the same types of gestures 103 can be detected, interpreted and commanded at the right hand corner 110 A back gesture is initiated with counter clockwise motion with the first input point(s) landing on the right vertical gesture area in off screen band 105, followed by input point(s) landing on the display 106 and finally input point(s) landing on the horizontal gesture area of off screen band 105. A next gesture, a clockwise motion, has its first input point(s) landing on the right horizontal gesture area of off screen band 105, followed by input point(s) landing on the display 106 and finally input point(s) landing on the vertical gesture area of off screen band 105.

The corner (navigation) gestures 103 have two main advantages over the existing tablet form factor navigation schemes, namely ergonomics and consistency that is independent of device orientation and dimension. The consistency comes from the fact that the gestures 103 are executed in the corners 109, 110 of the device 130 and that tablet devices 130 are typically held with two hands with at least one on the corner for navigation.

FIG. 1 further illustrates the screen capture circle gesture 101 of the present invention. As described above, in the preferred embodiment, the detected gesture 101 is mapped to the screen capture function. Even though this circle motion gesture 101 is preferably used for initiating a screen capture, it can easily be repurposed to perform another function when it is deem appropriate.

Unlike the corner gestures 103 which involves using both the horizontal and vertical gesture areas of band 105, the circle gesture 101 uses only one gesture area, either the vertical or horizontal but not both. Although shown as only being performed on the upper horizontal and right hand vertical side of device 130, the circle gesture 101 can be performed on any side of device 130. Further, although preferably performed in the center of a side of device 130 (as illustrated in FIG. 1) the circle gesture 101 can be performed anywhere along the selected side.

The sequence for the circle gesture 101 is fairly simple. The first input point lands on a gesture area of off screen band 105, for example top-horizontal gesture area. This is followed by one or more input point(s) on the display area 106. Finally, one or more input point(s) land on the same gesture area of off screen band 105 as the first point. For the gesture to be valid, the first point and the last point, e.g. points 1 and 5 in gesture 101 are preferably a safe distance (d1) apart in order to suppress faults or unintended triggers. In addition, the time stamp difference between the first and last point is preferably less 1 second, again, to avoid false detections. The radius of the circle of gesture 101 is preferably more than half of d1.

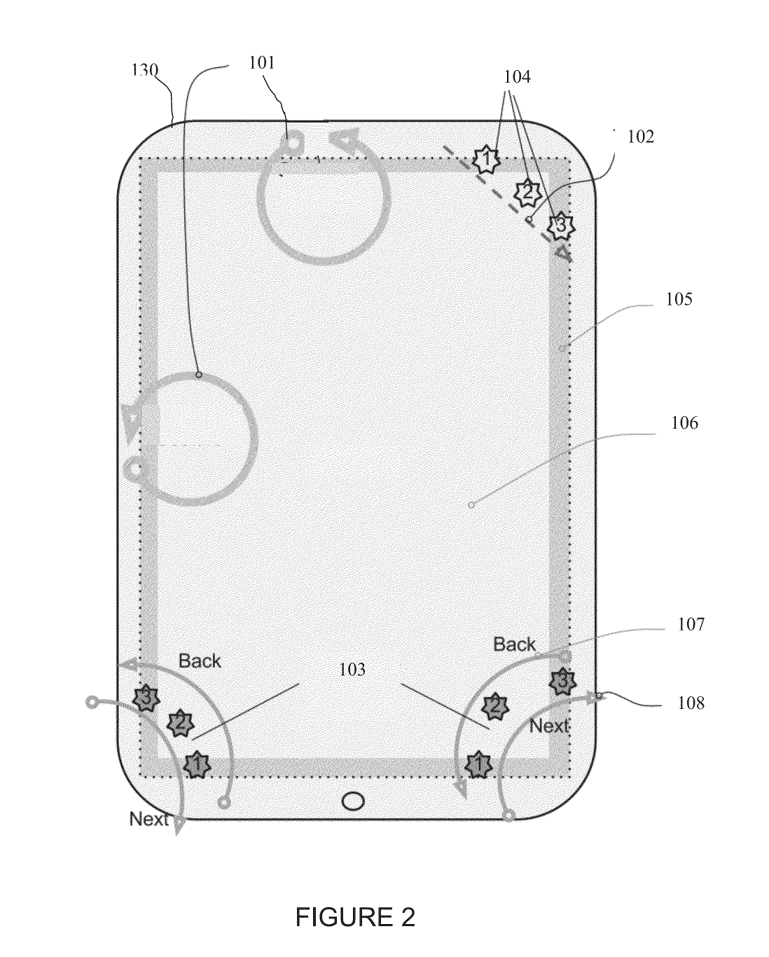

FIG. 2 illustrates the use of the off screen sensor band 105 as used in the portrait mode of device 130. As seen in this Figure, both the circular gesture 101, preferably used for screen capture, and the corner gestures 103, preferably used for back and next navigation, operates substantially the same when the device 130 is in the landscape mode as described above with respect to FIG. 1. As in the landscape orientation, the corner gestures 103 are performed on the lower corners of the device 130 and the circular screen capture gestures 101 can be performed on any side of the device 130.

FIG. 2 further illustrates an additional off-screen gesture 102, preferably used to bookmark a particular page in the electronic publication being viewed on device 130. Preferably, this gesture 102 is only valid on the top right corner of device 130 when used in the portrait orientation. One reason for this preference is that this bookmark gesture intuitively follows the physical act of dog-earing a page in a paper copy of a book. Further, it is preferable to use the upper right hand corner of the device 130 to avoid any confusion with the navigation gestures 103.

The bookmark gesture 102 starts at the top horizontal gesture area of off screen sensor band 105, then hits the display area 106 and finally lands on the right vertical gesture area off screen sensor band 105. Once detected, the application running on device 130 interprets gesture 102 as a bookmarking gesture and inserts the appropriate bookmark in association with the page being viewed in the electronic publication being displayed.

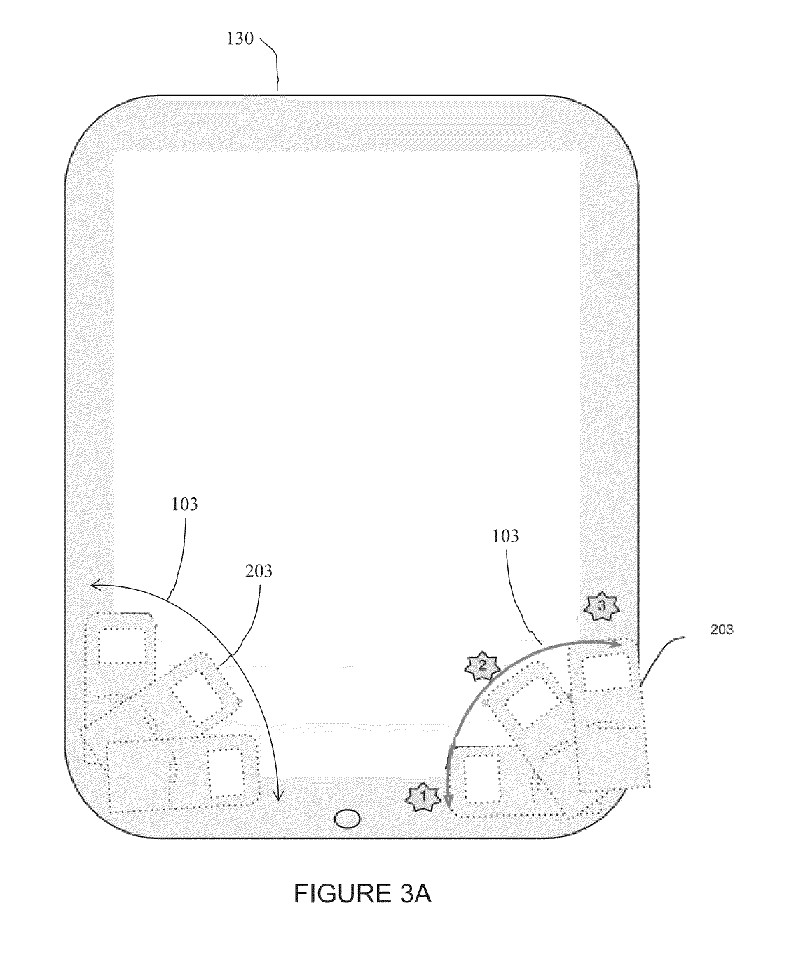

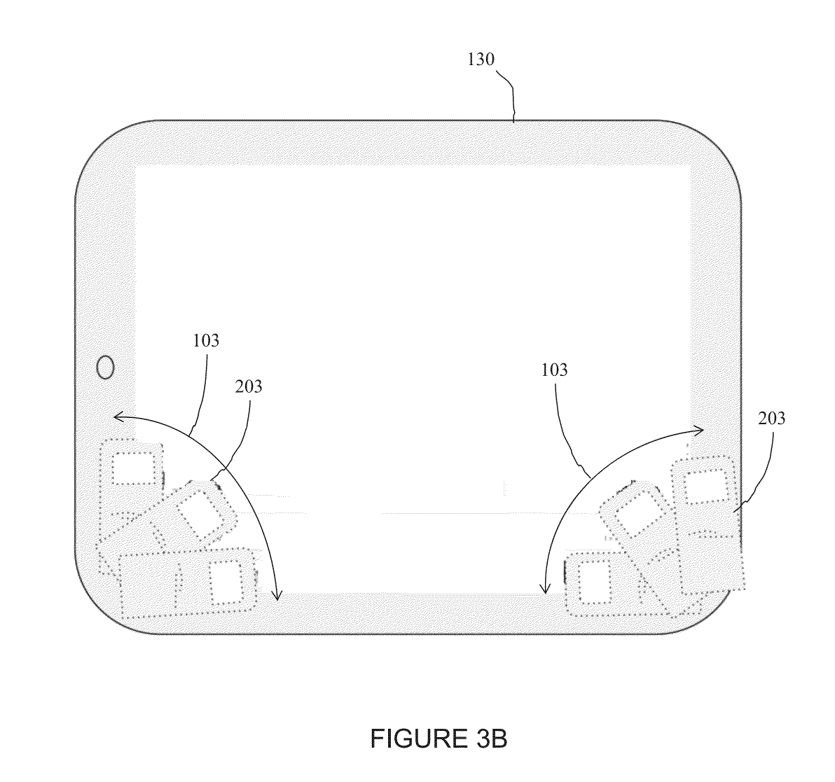

FIGS. 3A and 3B illustrate how the mechanics of the corner gestures 103 stays the same in portrait (FIG. 3A) and landscape (FIG. 3B) mode. In addition, the corner gestures 103 can be performed with minimum grip change because the windshield-wiper like movement is a more natural movement than a direct vertical or horizontal movement. As shown in FIGS. 3A and 3B, the user employs her thumb or other finger 203 to perform the gesture 103. As described above, in the preferred embodiment, a clockwise gesture 103 performs a next operation in the electronic publication being read, while a counterclockwise gesture 103 causes a back navigational function to be executed.

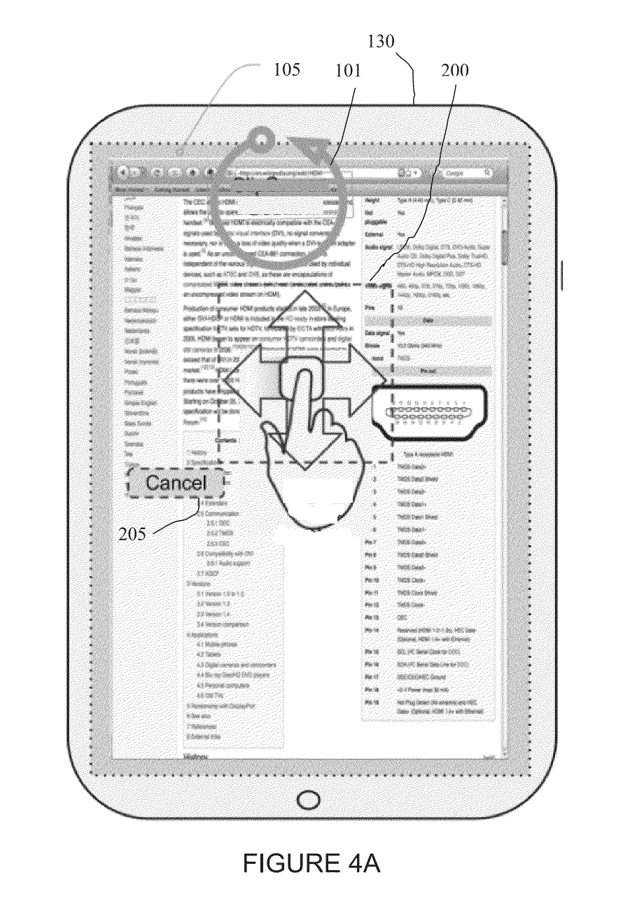

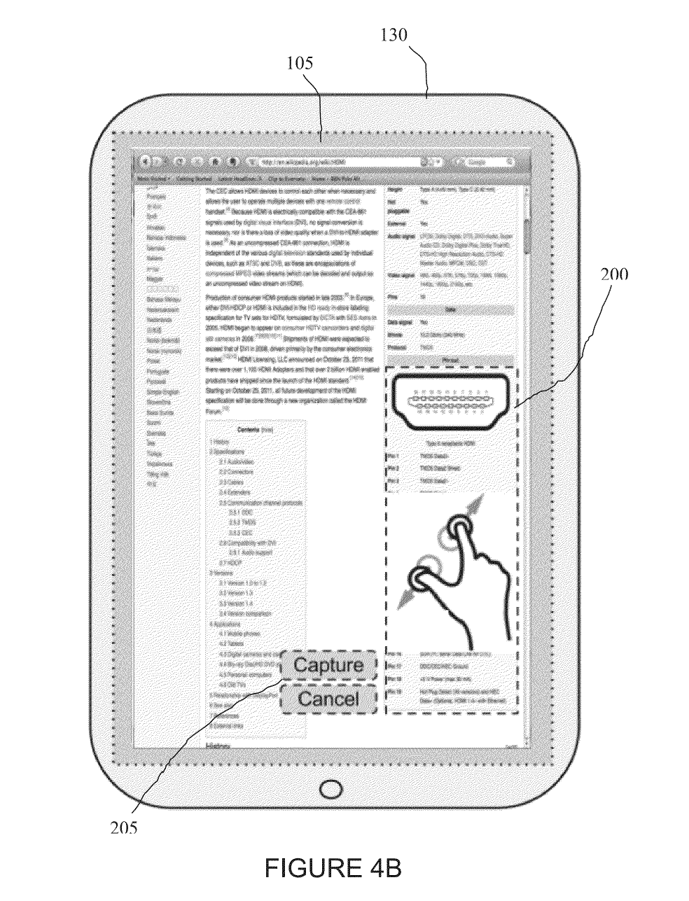

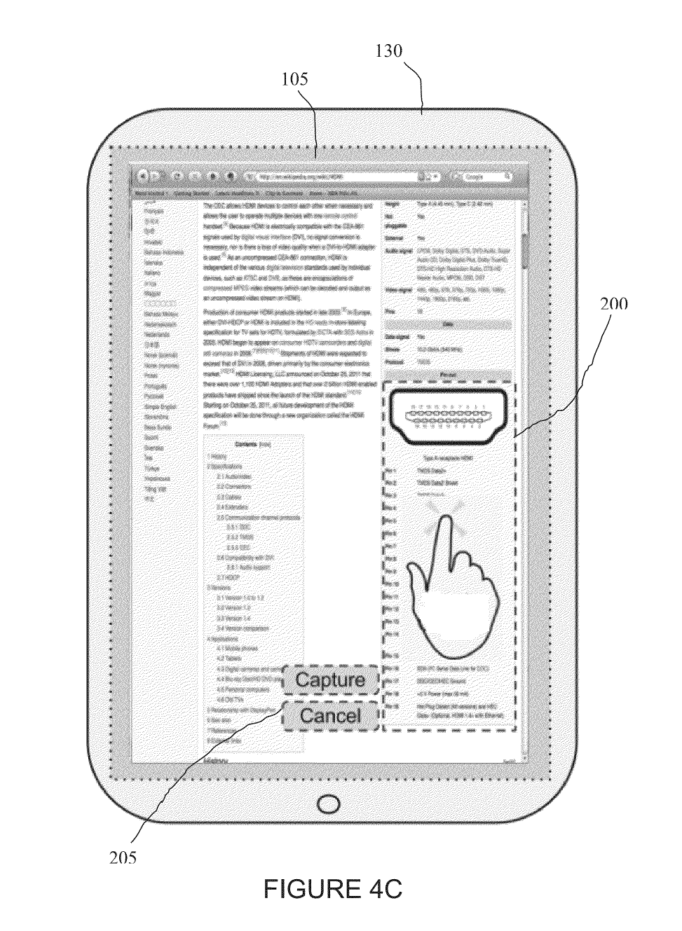

FIGS. 4A-4C illustrate the process of using circular gesture 101 to capture a screen shot. Using this gesture 101, the user can select and adjust the area of the screen to capture. As shown in FIG. 4A, the screen shot process is initiated with screen capture gesture 101. A capture selection box 200 is displayed along with controls, such as buttons 205 to capture and cancel the selection. As shown in FIGS. 4A and 4B, the user can drag the selection box 200 to the area of the screen she wishes to capture. When the box 200 is in the area she wishes to capture, the user can double tap the box 200 to fix it in place. Further, as shown in FIG. 4B, the user can use traditional gestures to resize the size of box 200 to encompass the parts of the screen she wants to capture. As shown in FIG. 4C, the user can either use the control 205 to capture the portion of the screen enclosed by box 200, or she can simply tap on the area within the box 200 to capture the image. Alternatively, she can tap the cancel button 205 to cancel the screen capture process.

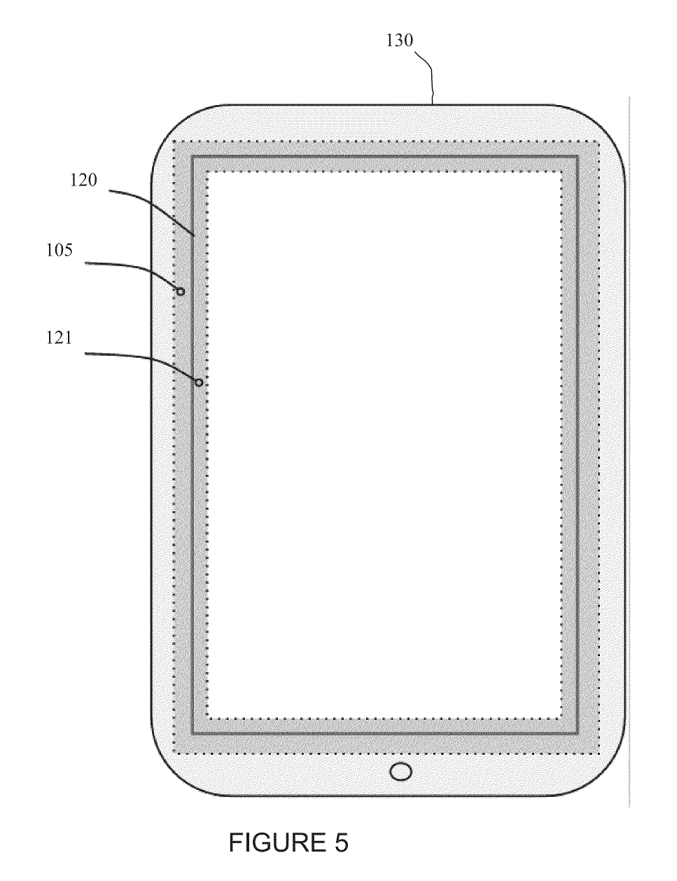

FIG. 5 illustrates a further embodiment of the present invention. As shown in FIG. 5, this embodiment of an electronic device 130 has the off screen gesture band 105 has described above, but also has an onscreen gesture band 121 defined in the active display area 120. The on-screen gesture band 121 does not require additional hardware support as the case with off-screen gesture band 105. On-screen gesture band 121 has constraints, including additional delays and operating system dependencies. For example, the Android operating system requires that all touches detected on the display active area 120 need to be reported and that all touch point are available for fair use by all applications. This means that in an Android device, the on-screen gestures system wide gestures may not be implementable as the gestures may not be unique across applications.

The 1-2-3 gesture detection points, as described above with respect to FIGS. 1 and 2 can all be located on the active screen area 120. All of the gestures described above can be implemented with on-screen gesture area/band 121 which lies just within, e.g., 2 mm to 3 mm, the boarder of the display active screen area 120 as shown in FIG. 5. It is further possible to also have hybrid gesture areas: part off-screen gesture area and part on-screen gesture area. For example, in a system that can only support off-screen gesture area 105 on the long-side of the device, on-screen gesture bands 121 can be use on the short side of the device. The 1-2-3 points would as such: point 1 is in the off-screen band 105, point-2 is unchanged in the active display area 120, and point-3 can be in the on-screen band 121.

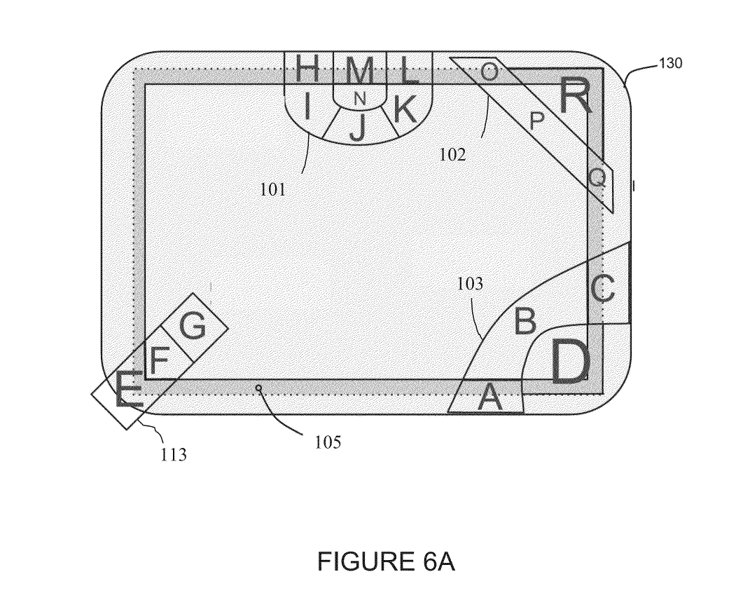

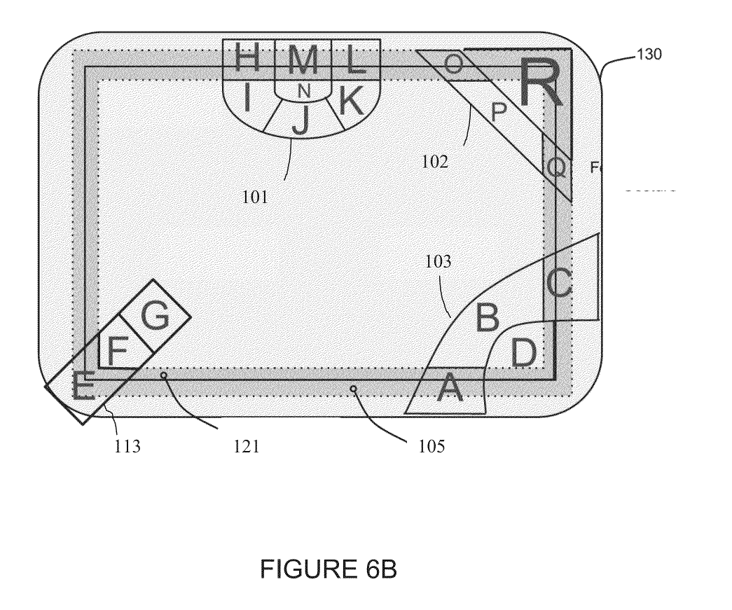

FIGS. 6A and 6B illustrate the subcomponents/regions of each gesture for off-screen and on-screen gesture band system respectively, including invalid regions.

Table 1 details the sequencing of the subcomponents/region for each gesture as shown in FIGS. 6A and 6B.

TABLE 1

| Gesture Name | Sequence | Comment |
|---|---|---|
| Next (103) | A-B-C | Region “D” is the invalid |
| | | zone which means that if the |
| | | gesture path enters the |
| | | region it will invalid the |
| | | gesture immediately |
| Previous (103) | C-B-A | Region “D” is the invalid |
| | | zone which means that if the |
| | | gesture path enters the |
| | | region it will invalid the |
| | | gesture immediately |
| Capture Screen | M/H-I-J-K-L-M or | Region “N” is the invalidate |
| Gesture (101) | M/L-K-J-I-H-M | zone. |
| Bookmark | O-P-Q | Region “R” is the invalidate |
| Gesture (102) | | zone. |
| Corner Launcher | E-F-G | |
| Gesture (113) | | |

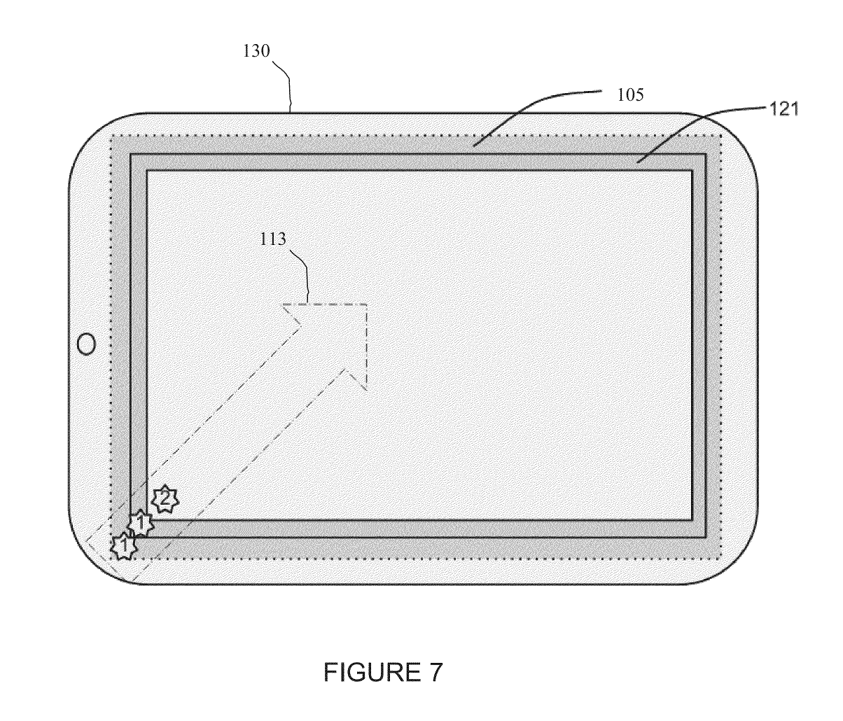

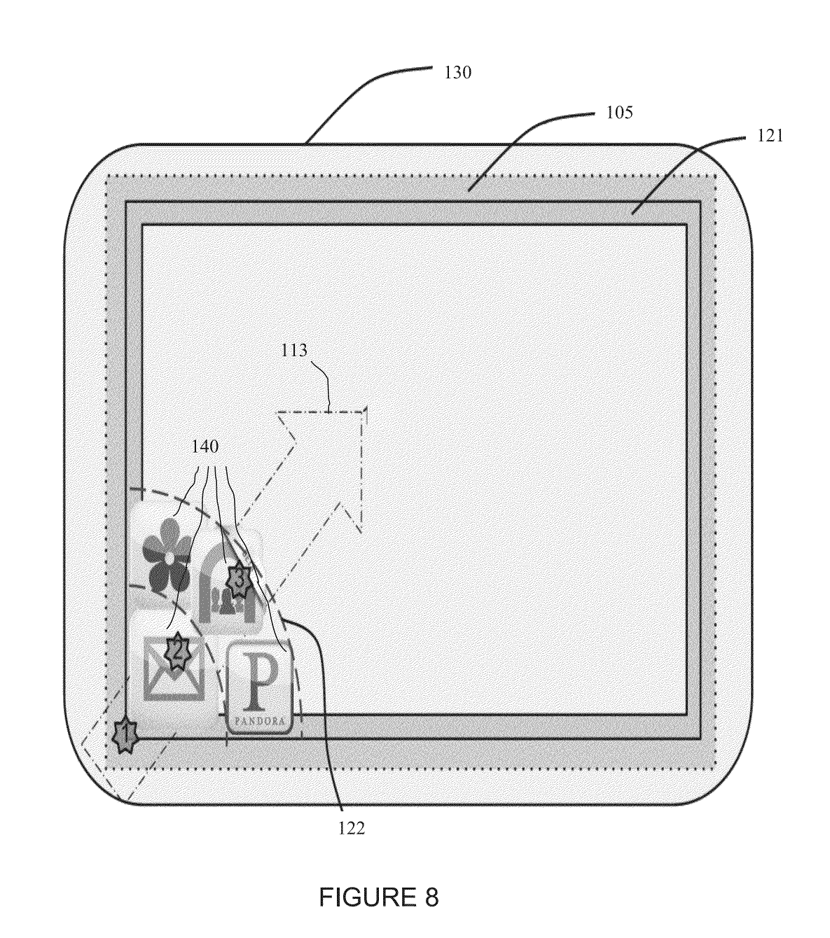

FIGS. 7 and 8 illustrate the corner launcher gesture 113 of the present invention. The Corner launcher is an extremely ergonomic gesture. As shown in FIGS. 7 and 8, the gesture 113 starts in a corner of device 130 at point 1. The launcher gesture 113 works in embodiments of the present invention with the off-screen band 105 and the with the on-screen hand 121. Point 1 can start in either band. Further, the gesture 113 can start in any corner and works in both the landscape and portrait modes of the device 130.

As shown in these Figures, the launcher gestures 113 is a diagonal upward motion through points 1-2-3 that can be executed easily by flicking the thumb, while the user is holding the device 130. The launcher gesture 113 has all the advantage as the other gestures as it is consistent for portrait or landscape orientation, as well as for left-handed and right handed users.

As shown in FIG. 8, although the gesture 113 can be used for any number of functions, in a preferred embodiment, the launcher gesture is best used as “quick dial” for the “home” button or key on the device 130 that typically brings together the collection of most often used applications 140. Icons for the most used applications 140 are brought up in the corner where the launcher gesture 113 was invoked. This brings the most frequently used applications 140 to the corner where it is most convenient to reach and execute, “launch.”

The launcher gesture 113 is preferably implemented with a toggle function. The first time the gesture is executed, the home screen is displayed. The execution of a subsequent launcher gesture dismisses the home screen. The toggle feature is very user friendly because no repositioning of the hand is required to perform a different gesture.

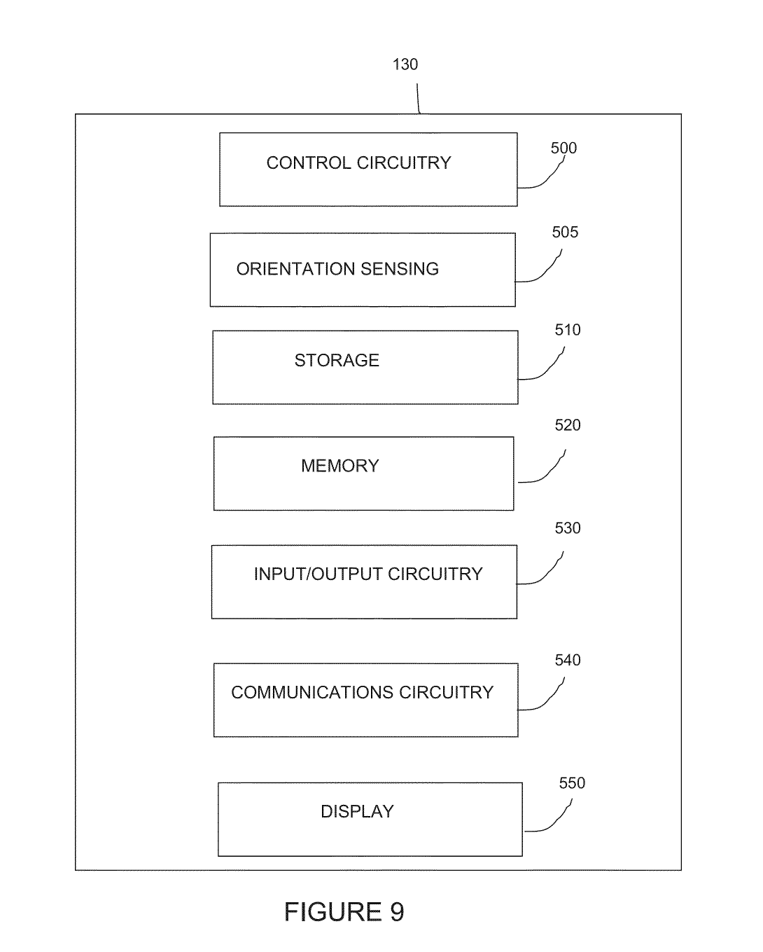

FIG. 9 illustrates an exemplary device 130. As appreciated by those skilled the art, the device 130 can take many forms capable of operating the present invention. As previously described, in a preferred embodiment the device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in this Figure, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal email device, a personal data assistant (“PDA”), a cellular telephone, a handheld gaining device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 include orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 510 can include, for example, one or more tangible computer storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 430 to establish a wireless connection), subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise non transient software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in this Figure as a single component of electronic device 130, several instances of 170 circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

As described above, for a capacitive touch panel, a touch sensor sheet, typically made from glass or optically clear plastic film, goes on top of the display 550. The touch sensor sheet is typically larger than display visible area as extra space is need route the invisible trace or wires. On top of the touch sensor sheet is the cover glass which is what the user physically touches. The cover glass is typically larger than the touch sensor sheet and the display. The off-screen gesture band/area described herein requires only enlarging the sensor area by, for example 3 mm, beyond the display visible area. This typically requires the mechanical design to make allowance for the extra space.

in some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronics device 130. In some embodiments, the display circuitry can include a coder/decoder (Codec) to convert digital media, data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, WiFi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOW, or any other suitable protocol.

Electronic device 130 can include one more instances of communications circuitry 540 for simultaneously performing several communications operations using different communications networks, although only one is shown in FIG. 5 to avoid overcomplicating the drawing. For example, electronic device 130 can include a first instance of communications circuitry 540 for communicating over a cellular network, and a second instance of communications circuitry 540 for communicating over or using Bluetooth. In some embodiments, the same instance of communications circuitry 540 can be operative to provide for communications over several communications networks.

In some embodiments, electronic device 130 can be coupled to a host device such as a digital content control server for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A system for detecting and executing a gesture comprising:
a display having an active display area;
an on-screen touch sensor array disposed in registration with the active display area;
an off-screen touch sensor array disposed adjacent to the on-screen touch sensor array and not in registration with the active display area;
a memory that includes instructions for operating the system;
control circuitry coupled to the memory, coupled to the display, coupled to the on-screen touch sensor array, and coupled to the off-screen touch sensor array, the control circuitry capable of executing the instructions and is operable to at least:
receive at least one off-screen touch input detected by the off-screen touch sensor array;
receive at least one on-screen touch input detected by the on-screen touch sensor array, wherein the at least one off-screen and on-screen touch inputs are part of a single gesture;
determine the single gesture associated with the at least one off-screen and on-screen touch inputs; and
execute a function associated with the single gesture.

2. The system of claim 1, wherein the on-screen touch sensor array and the off-screen touch sensor array are integrally formed.

3. The system of claim 1, wherein the function executed by the control circuitry is to display icons representing executable applications on the display.

4. The system of claim 1, wherein the at least one off-screen touch input is a first off-screen touch input, wherein the control circuitry is further operable to execute the instructions to receive a second off-screen touch input from the off-screen touch sensor array.

5. The system of claim 4, wherein the first and second off-screen inputs are received from sensors of the off-screen touch sensor array disposed adjacent a same side of the active display, and wherein the function executed by the control circuitry is to capture a screen on the display.

6. The system of claim 5, wherein the control circuitry is further operable to execute the instructions to:
display a capture selection box on the display;
receive drag inputs from the on-screen sensor array, and move the capture selection box on the display in response to the drag inputs;
receive resize inputs from the on-screen sensor array, and resize the capture selection box on the display in response to the resize inputs; and
capture the screen in response to a capture input received from the on-screen sensor array.

7. The system of claim 4, wherein the first off-screen input is received from sensors of the off-screen touch sensor array disposed adjacent a first side of the active display, wherein the second off-screen input is received from sensors of the off-screen touch sensor array disposed adjacent a second side of the active display, wherein the first and second sides of the active display are substantially perpendicular, and wherein the function executed by the control circuitry is to electronically bookmark a page of an electronic document being displayed on the display.

8. The system of claim 1 further comprising:
a vertical gesture area comprising sensors of the off-screen touch sensor array disposed adjacent a vertical side of the display; and
a horizontal gesture area comprising sensors of the off-screen touch sensor array disposed adjacent a horizontal side of the display.

9. The system of claim 8, wherein the at least one off-screen touch input is a first off-screen touch input and is received from sensors in one of the vertical gesture area or the horizontal gesture area, wherein the control circuitry is further operable to execute the instructions to receive a second off-screen touch input from sensors in the other of the vertical gesture area or the horizontal gesture area.

10. The system of claim 9, wherein the function executed by the control circuitry is a navigation function in an electronic publication displayed on the display.

11. The system of claim 10, wherein the navigation function displays a next page in the electronic publication if the single gesture is a clockwise gesture and displays a previous page in the electronic publication if the single gesture is a counter clockwise gesture.

12. The system of claim 1, wherein the on-screen touch sensor array further comprises an on-screen gesture band consisting of sensors adjacent the off-screen touch sensor array.

13. A system for detecting and executing a gesture comprising:
a display having an active display area;
an on-screen touch sensor array disposed in registration with the active display area, wherein the on-screen touch sensor array further comprises on-screen gesture band consisting of sensors adjacent a perimeter of the active display area;
a memory that includes instructions for operating the system;
control circuitry coupled to the memory, coupled to the display, and coupled to the on-screen touch sensor array, the control circuitry capable of executing the instructions and is operable to at least:
receive a first touch input detected by sensors in the on-screen gesture band;
receive second touch input detected by sensors not in the on-screen gesture band, wherein the first and second touch inputs are part of a single gesture;
determine the single gesture associated with the first and second touch inputs; and
execute a function associated with the single gesture.

14. A method for detecting and executing a gesture in an electronic device having a display with an active display area, the method comprising:
receiving, by control circuitry, at least one on-screen touch input detected by an on-screen touch sensor array, the on-screen touch sensor array disposed in registration with the active display area
receiving, by the control circuitry, at least one off-screen touch input detected by an off-screen touch sensor array, the off-screen touch sensor array disposed adjacent to the on-screen touch sensor array and not in registration with the active display area, wherein the at least one off-screen and on-screen touch inputs are part of a single gesture;
determining, by the control circuitry, the single gesture associated with the at least one off-screen and on-screen touch inputs; and
executing, by the control circuitry, a function associated with the single gesture.

15. The method of claim 14, wherein the act of executing the function further comprises displaying icons representing executable applications on the display.

16. The method of claim 14, wherein the at least one off-screen touch input is a first off-screen touch input, the method further comprising receiving a second off-screen touch input from the off-screen touch sensor array.

17. The method of claim 16, wherein the first and second off-screen inputs are received from sensors of the off-screen touch sensor array disposed adjacent a same side of the active display, and wherein the act of executing the function further comprises capturing a screen on the display.

18. The method of claim 16, wherein the first off-screen input is received from sensors of the off-screen touch sensor array disposed adjacent a first side of the active display, wherein the second off-screen input is received from sensors of the off-screen touch sensor array disposed adjacent a second side of the active display, wherein the first and second sides of the active display are substantially perpendicular, and wherein the act of executing the function further comprises electronically bookmarking a page of an electronic document being displayed on the display.

19. The method of claim 14, wherein the at least one off-screen touch input is a first off-screen touch input, the method further comprising:
receiving the first off-screen touch input from sensors in a vertical gesture area of the off-screen touch sensor array disposed adjacent a vertical side of the display; and
receiving a second off-screen touch input from sensors in a horizontal gesture area of the off-screen touch sensor array disposed adjacent a horizontal side of the display.

20. The method of claim 19, wherein the function is a navigation function in an electronic publication displayed on the display.
